(19) United States
(12) Patent Application Publication
(10) Pub. No.: US 2024/0272920 A1
(43) Pub. Date: Aug. 15, 2024

(54) SYSTEMS AND METHODS TO PROVIDE AUTOMATED ASSISTANCE IN CHAT SESSIONS BETWEEN USERS OF A COLLABORATION ENVIRONMENT

(71) Applicant: Asana, Inc., San Francisco, CA (US)

(72) Inventors: Alvaro Morales, San Francisco, CA (US); Eric Lee Campbell, Oakland, CA (US); Manya Sofia Spieczny Scheps, Berkeley, CA (US)

(21) Appl. No.: 17/108,302

(22) Filed: Dec. 1, 2020

(51) Int. Cl. G06F 9/451; G06F 40/56; H04L 12/58; H04L 29/06

(52) U.S. Cl. CPC G06F 9/453; G06F 40/56; H04L 51/02; H04L 65/4053

(57) ABSTRACT

Systems and methods for providing automated assistance in chat sessions between users of a collaboration environment are described. Exemplary implementations may: obtain content information characterizing content of the chat sessions between the users of the collaboration environment; identify content items based on the content from the chat sessions; effectuate presentation of one or more automated communications within the chat sessions that correspond to the one or more content items identified based on the content from the chat sessions where presentations of the one or more automated communications suspends the sending of the content to a receiving user of the chat sessions; and/or other perform other operations.

### FIELD OF THE DISCLOSURE

The present disclosure relates to systems and methods for providing automated assistance in chat sessions between users of a collaboration environment.

### BACKGROUND

In managing to-do items or other work, users may communicate amongst each other often. Persistent communications for relatively simple questions and/or requests from users may be disruptive to a receiving user if the receiving user is constantly being engaged in chat sessions by other users.

### SUMMARY

One aspect of the present disclosure relates to a system configured for providing automated assistance in chat sessions between users of a collaboration environment. The assistant may include automatically presenting relevant content items to a message-sending user of the chat sessions prior to the message being sent to one or more other users. The content items may be identified dynamically for the users participating in the chat sessions through the graphical chat interface and/or based on content from the chat sessions through the graphical chat interface. Upon identifying the content items, presentation of the content items may be effectuated in the graphical chat interface for immediate access to the user(s) who sent a message in the chat session. Thus, the other users are alleviated from being queried and/or from receiving a plurality of messages, therefore increasing work productivity amongst all users.

One aspect of the present disclosure relates to a system for providing automated assistance in chat sessions between users of a collaboration environment. The system may include one or more of server(s), chat server(s), client computing platform(s), and/or other components. The one or more servers may be configured to communicate with one or more client computing platforms according to a client/server architecture and/or other architecture. The one or more servers, chat servers, and/or client computing platforms may include one or more physical processors configured to execute one or more computer program components. The computer program components may include one or more of an environment state component, a chat application component, a collaboration environment component, content component, automated assistance component, and/or other components.

The environment state component may be configured to manage environment state information maintaining the collaboration environment. The collaboration environment may be configured to facilitate interaction by users with the collaboration environment. In some implementations, the environment state information may include work unit records describing units of work assigned to, created by, and/or managed by individual users within the collaboration environment, and/or other records. In some implementations, environment state component may be configured to effectuate transmission of the environment state information to client computing platform(s), and/or vice versa. In some implementations, the environment state component may be configured to receive information over a network from the client computing platforms(s).

The content component may be configured to obtain content information characterizing content of the chat sessions between the users of the collaboration environment. The chat sessions may facilitate one or more of synchronous, semi-synchronous, and/or asynchronous communication between the users. The chat sessions may include a first chat session between a first user and a second user and/or other chat sessions between other users. By way of non-limiting illustration, first content information may characterize first content communicated from the first user to the second user of the first chat session.

The content component may be configured to identify one or more content items and/or other information. The one or more content items may be identified based on the content of the chat sessions communicated from individual users and/or other information. The one or more content items may be identified prior to sending the content to other ones of the individual users in the chat sessions. By way of non-limiting illustration, a first content item may be identified from the first content communicated from the first user and prior to sending the first content to the second user and/or other users of the first chat session.

The automated assistance component may be configured to effectuate presentation of one or more automated communications within the chat sessions that correspond to the one or more content items identified from the content of the chat sessions. The presentation of individual automated communications in the chat sessions may suspend the sending of the content to the other ones of the individual users in the chat sessions. By way of non-limiting illustration, a first automated communication may be presented in the first chat session for the first user and/or other users. The first automated communication may correspond to the first content item. The presentation of the first automated communication may suspend the sending of the first content to the second user and/or other users of the first chat session.

These and other features, and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

FIG. 1 illustrates a system configured to provide automated assistance in chat sessions between users of a collaboration environment, in accordance with one or more implementations.

FIG. 2 illustrates an exemplary chat interface, in accordance with one or more implementations.

FIG. 3 illustrates an exemplary chat interface, in accordance with one or more implementations.

FIG. 4 illustrates a method to provide automated assistance in chat sessions between users of a collaboration environment, in accordance with one or more implementations.

### DETAILED DESCRIPTION

Providing automated assistance by effectuating presentation of one or more automated communications within chat sessions of a collaboration environment may facilitate minimizing disruptive communications between users. Content items may be identified dynamically for one or more users participating in a chat session through the graphical chat interface and/or based on content from the chat session through the graphical chat interface. One or more automated communications corresponding to the content times may be automatically presented to the sender of a communication, and/or other users. The content items may be presented in real-time within a given chat session, near-real time within the given chat session, and/or at an other time during the given chat session. The presentation of the one or more automated communications may cause suspension of the sending the disruptive communications to other users of the chat sessions. Thus, communications such as questions and/or requests may be fulfilled by the one or more automated communications without disrupting a recipient.

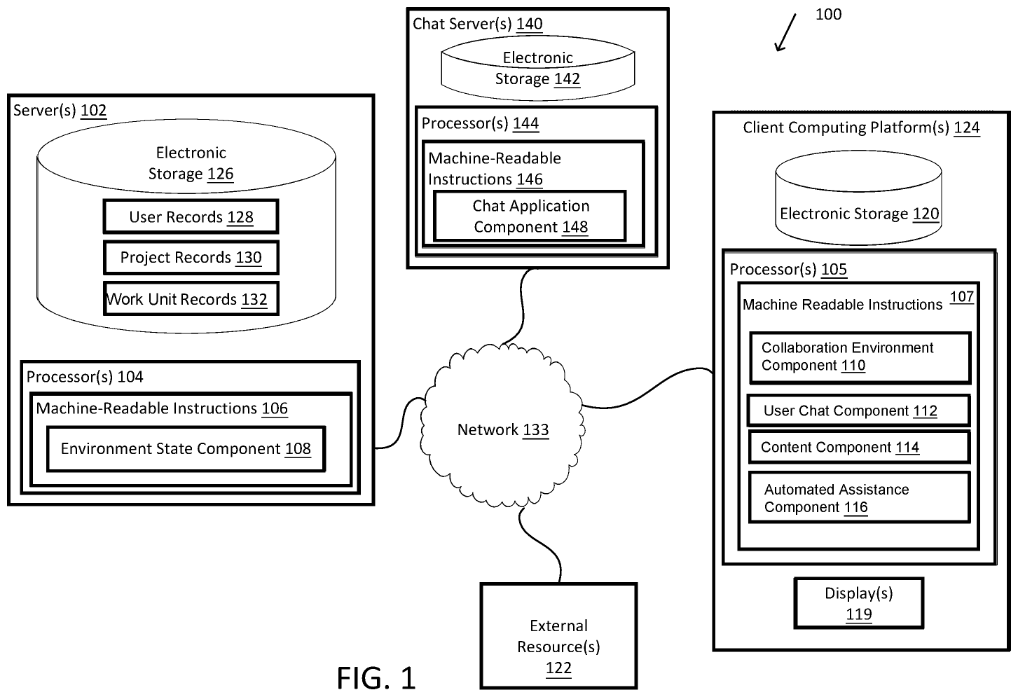

As is illustrated in FIG. 1, system 100 may include one or more of: one or more servers 102, one or more chat servers 140, one or more client computing platforms 124, external resource(s) 122, and/or other components. Users may interact with system 100 via one or more client computing platforms 124. The one or more servers 102 and/or chat server(s) 140 may be configured to communicate with one or more client computing platforms 124 according to a client/server architecture and/or other communication schemes. The one or more client computing platforms 124 may include one or more of a cellular telephone, a smartphone, a digital camera, a laptop, a tablet computer, a desktop computer, a television set-top box, smart TV, a gaming console, and/or other client computing platforms.

The one or more servers 102 may include one or more of one or more physical processors 104, non-transitory electronic storage 126, and/or other components. Non-transitory electronic storage 126 may include one or more records. The records may include user records 128, project records 130, work unit records 132, objective records (not shown), and/or other records. The one or more physical processors 104 may be configured to access one or more of the records to effectuate transmission of the environment state information over network 133 to client computing platform(s) 124

The chat server(s) 140 may include one or more of one or more physical processors 144, non-transitory electronic storage 142, and/or other components.

The client computing platform(s) 124 may include one or more physical processors 105, non-transitory electronic storage 120, one or more displays 119, and/or other components. The client computing platform(s) 124 may monitor, and/or collect information for transmission to the one or more server(s) 102 to be stored as environment state information. The client computing platform(s) 124 may obtain and/or collect environment state information from the one or more server(s) 102. Client computing platform(s) 124 may use the environment state information to effectuate presentation of the collaboration environment via display(s) 119.

The physical processor(s) 104, physical processor(s) 144, and/or physical processor(s) 105 may be configured to execute machine-readable instructions 106, machine-readable instructions 146, and/or machine-readable instructions 107, respectively. Machine-readable instructions may include one or more computer program components. The computer program components may include one or more of an environment state component 108, a chat application component 148, a collaboration environment component 110, a user chat component 112, a content component 114, an automated assistance component 116, and/or other components.

It is noted that while some computer program components may be shown and described as attributed to an individual one of or more of chat servers(s) 140, client computing platform(s) 124, and/or server(s) 102, this is for illustrative purposes only. Instead, it is to be understand that the features and/or functionality of one of these entities may be additionally and/or alternatively be attributed to another one of these entities.

In some implementations, server(s) 102 and/or chat server(s) 140 may be configured to provide remote hosting of the features and/or functions of their respective machine-readable instructions to one or more client computing platform(s) 124 that may be remotely located from server(s) 102 and/or chat server(s) 140. In some implementations, one or more features and/or functions of server(s) 102 and/or chat server(s) 140 may be attributed as local features and/or functions of one or more client computing platform(s) 124. For example, individual ones of the client computing platform(s) 124 may include one or more additional machine-readable instructions comprising the same or similar components as machine-readable instructions 106 of server(s) 102 and/or machine-readable instructions 146 of chat server(s) 140. The client computing platform(s) 124 may be configured to locally execute the one or more components that may be the same or similar to the machine-readable instructions 106. One or more features and/or functions of machine-readable instructions 106 of server(s) 102 may be provided, at least in part, as an application program that may be executed at a given client computing platform 124. One or more features and/or functions of machine-readable instructions 107 may be provided, at least in part, at a server(s) 102.

The electronic storage 126, electronic storage 142, and/or electronic storage 120 may include electronic storage media that electronically stores information. The electronic storage media of electronic storage 126, electronic storage 142, and/or electronic storage 120 may include one or both of system storage that is provided integrally (i.e., substantially non-removable) and/or removable storage that is removably connected. The connection may be facilitated by, for example, a port (e.g., a USB port, a firewire port, etc.) or a drive (e.g., a disk drive, etc.).

The electronic storage 126, electronic storage 142, and/or electronic storage 120 may individually include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storage 126, electronic storage 142, and/or electronic storage 120 may individually include one or more virtual storage resources (e.g., cloud storage, a virtual private network, and/or other virtual storage resources). The electronic storage 126, electronic storage 142, and/or electronic storage 120 may store software algorithms, information determined by various entities described herein, and/or other information that enables chat server(s) 140, server(s) 102, and/or client computing platform(s) 124 to function as described herein.

The electronic storage 126 may be configured to store one or more records and/or information. The one or more records may include one or more of user records 128, project records 130, work unit records 132, objective records (not shown), and/or other records. The one or more records may specify and or define values for one or more user parameters, project parameters, and/or other parameters for the collaboration environment. The one or more records may specify correspondences between one or more of the user records 128, project records 130, work unit records 132, and/or other records. The correspondences may be used to determine which user parameters and/or values, project parameters and/or values, and/or work unit parameters and/or values are associated with a given user, project, and/or unit of work within the collaboration environment.

The presentation of a collaboration environment may be based on environment state information. The environment state information may include user records 128, project records 130, work unit records 132, and/or other records. The environment state information may be continuously generated and/or updated based on the state of the collaboration environment representing the users' interactions with the collaboration environment. The state of the collaboration environment may include a user state, a project state, a work unit state, and/or other states. The user state may be defined by user records 128. User records 128 may define user information associated with users interacting with and/or viewing the collaboration environment. The project state may be defined by project records 130. Project records 130 may define project information for projects managed within the collaboration environment. Managing may include one or more of obtaining, defining, storing, updating, deleting, and/or other operations. The work unit state may be defined by work unit records 132. Work unit records 132 may define values of work information for units of work created and/or assigned within the collaboration environment. Objective records may define objective information for business objectives.

The user information in user records 128 may include values of user parameters for individual users, and/or other information. The values of user parameters may, by way of non-limiting example, specify one or more of: a user name, a group parameter, a user account, user role information, a user department, descriptive user content, a to-email, a from-email, a photo, an organization, a workspace, one or more projects (which may include project parameters defined by one or more work unit records), one or more business objectives owned and/or managed by a user, one or more items of work (which may include one or more unit of work parameters defined by one or more unit of work records), one or more user comments, one or more teams the user belongs to, one or more of the user display settings (e.g., colors, size, project order, task order, other unit of work order, etc.), one or more authorized applications, one or more interaction parameters (e.g., indicating a user is working on/worked on a given unit of work, a given user viewed a given unit of work, a given user selected a given unit of work, a timeframe a given user last interacted with and/or worked on a given unit of work, a time period that a given unit of work has been idle, and/or other interaction parameters), a presence parameter (e.g., indicating presence and/or interaction level at an environment level, unit of work level, project level, task level, application level, business objective level, etc.), one or more notification settings, one or more progress parameters, status information for one or more units of work the user is associated with (units of work assigned to the user, assigned to other users by the user, completed by the user, past-due date, and/or other information), one or more performance metrics of a given user (e.g., how many units of work the user has completed, how quickly the user completed the units of work, how quickly the user completes certain types of units of work, the efficiency of the user, bandwidth of the user, activity level of the user, how many business objectives the user has helped fulfill through their completion of units of work, etc.), application access information (e.g., username/password for one or more third-party applications), one or more favorites and/or priorities, schedule information, other user parameters for the given user.

User role information may specify individual roles of the individual users in the individual units of work, projects, and/or business objectives. A role may represent a position of an individual user. The position may be specified based on a description of one or more of job title, level, stage, and/or other descriptions of position. The role may be specified with respect to a company as a whole, a particular unit of work, a particular business objective, a particular project, and/or other considerations. By way of non-limiting illustration, a role may include one or more of chief executive officer (or other officer), owner, manager, supervisor, accountant, associate, employee, entry level, midlevel, senior, administrator, director, foreman, engineer, product developer, human resource officer, artist, art director, and/or other description.

Schedule information for the individual users may include one or more calendar entries associated with the individual users. The individual calendar entries may be associated with individual start dates and individual end dates. In some implementations, schedule information may be stored locally within electronic storage 120 by virtue of features and/or functionality provided within a collaboration environment. By way of non-limiting illustration, a collaboration environment may have the features and/or functionality of calendar application configured to facilitate calendaring entries into a schedule. It is noted that schedule information may be determined through features and/or functionality provided by one or more external resources 122. By way of non-limiting illustration, an external resource may include a calendar application which may be external to a collaboration environment. The collaboration environment may have permissions to access the external calendar application to determine and/or obtain schedule information.

The work information in work unit records 132 may include values of one or more work unit parameters. The values of the work unit parameters may be organized in work unit records corresponding to units of work managed, created, and/or assigned within the collaboration environment. A given unit of work may have one or more assignees and/or team members working on the given unit of work. Units of work may be associated with one or more to-do items, action items, objectives, and/or other units of work one or more users should accomplish and/or plan on accomplishing. Units of work may be created by a given user for the given user and/or created by the given user and assigned to one or more other users. A given unit of work may include one or more of a task, a sub-task, and/or other units of work possibly assigned to and/or associated with one or more users.

Individual sets of work unit records may be defined by a record hierarchy. A record hierarchy may convey individual positions of work unit records (and their corresponding units of work) in the record hierarchy. By way of non-limiting illustration, a position may specify one or more of a work unit record being superior to another work unit record, a work unit record being subordinate to another work unit record, and/or other information. As a result, individual work unit records in the individual sets of work unit records may be subordinate to other individual work unit records in the individual sets of work unit records. For example, a work unit record may define a unit of work comprising a task, and a subordinate work unit record may define unit of work comprising a sub-task to the task. A record hierarchy may define a relationship between work unit records. A work unit record may have some restrictions placed on it by virtue of having a subordinate work unit record. By way of non-limiting illustration, a work unit record may be restricted from access by one or more users unless and/or until a subordinate work unit record is completed and/or started. In some implementations, the work unit records may include a first work unit record describing a first unit of work assigned to a first user and/or other work unit records. The first unit of work may include a first digital content item and/or other information.

Individual work unit records may include hierarchical information defining a record hierarchy of the individual work unit records. The hierarchical information of a work unit record may include one or more of information identifying other work unit records associated in a record hierarchy the work unit record belongs to, a specification of the position of the work unit record in the hierarchy, restrictions and/or other relationships placed on the work unit record by virtue of its position, and/or other information.

The one or more work unit parameters may include one or more of a work assignment parameter, a work management parameter, work creation parameter, and/or other parameters. The values of the work assignment parameter may describe units of work assigned to the individual users. The values of the work management parameter may describe units of work managed by the individual users. The values of the work creation parameter may describe units of work created by the individual users.

In some implementations, values of one or more work unit parameters of a given unit of work may describe the unit of work based on one or more of: a unit of work name, a unit of work description, one or more unit of work dates (e.g., a start date, a due date, an end date, a completion date, and/or dates), one or more members associated with a unit of work (e.g., an owner, one or more other project/task members, member access information, and/or other unit of work members and/or member information), a status parameter (e.g., an update, a hardcoded status update, a completed/uncomplete/mark complete, a measured status, a progress indication, quantity of sub-work units remaining for a given unit of work, completed units of work in a given project, and/or other status parameter), one or more user comment parameters (e.g., permission for who may comments such as a creator, a recipient, one or more followers, and/or one or more other interested parties; content of the comments; one or more times; presence or absence of the functionality of up-votes; one or more hardcoded responses; and/or other parameters), one or more business objectives the unit of work is associated with, one or more interaction parameters (e.g., indicating a given unit of work is being worked on/was worked on, given unit of work was viewed, a given unit of work was selected, how long the given unit of work has been idle, a last interaction parameter indicating when and what user last interacted with the given unit of work, users that interacted with the given unit of work, and/or other interaction parameters indicating sources of the interactions, context of the interactions, content of the interactions and/or time for the interactions), one or more file attachments, notification settings, privacy, an associated URL, one or more interaction parameters (e.g., sources of the interactions, context of the interactions, content of the interactions, time for the interactions, and/or other interaction parameters), updates, ordering of units of work within a given unit of work (e.g., tasks within a project, subtasks within a task, etc.,), state of a workspace for a given unit of work (e.g., application state parameters, application status, application interactions, user information, and/or other parameters related to the state of the workspace for a unit of work), dependencies between one or more units of work, one or more custom fields (e.g., priority, cost, stage, and/or other custom fields), quantities of work production for the unit of work (e.g., quantity of lines of code, quantity of lines of copy, etc.), and/or other information.

The values of the work assignment parameter describing units of work assigned to the individual users may be determined based on one or more interactions by one or more users with a collaboration environment. In some implementations, one or more users may create and/or assign one or more unit of work to themselves and/or another user. In some implementations, a user may be assigned a unit of work and the user may effectuate a reassignment of the unit of work from the user or one or more other users.

In some implementations, values of the work assignment parameter may indicate that a status parameter of a unit of work has changed from “incomplete” to “marked complete” and/or “complete”. In some implementations, a status of complete for a unit of work may be associated with the passing of an end date associated with the unit of work. In some implementations, a status of “marked complete” may be associated with a user providing input via the collaboration environment at the point in time the user completes the unit of work (which may be before or after an end date). In some implementations, units of work created by, assigned to, and/or completed by the users may refer generally to a linking of the units of work with the individual users in the collaboration environment. A unit of work may be linked with a user in a manner that defines one or more relationships between the user and the unit of work. Such a relationship may connote and/or be a result of an action (past, present, and/or future) of the user with respect to the unit of work. Such actions may include one or more of creating a work unit record for a unit of work, being assigned to participate in a unit of work, participating in a unit of work, being granted access to a work unit record of a unit of work, adjusting a value of a parameter of a work unit record of a unit of work, and/or other actions.

The project information in project records 130 may define values of project parameters for projects managed within the collaboration environment. The project parameters may characterize one or more projects managed within the collaboration environment and/or via the collaboration work management platform, and/or the metadata associated with the one or more projects. Individual ones of the projects may be associated with individual ones of the project records. The project information may define values of the project parameters associated with a given project managed within the collaboration environment and/or via the collaboration work management platform. A given project may have one or more owners and/or one or more team members working on the given project. The given project may include one or more units of work assigned to one or more users under the given project heading.

The values of the project parameters may, by way of non-limiting example, include one or more of: one or more units of work within individual ones of the projects (which may include task parameters defined by one or more work unit records), one or more user comment parameters (e.g., a creator, a recipient, one or more followers, one or more other interested parties, content, one or more times, upvotes, other hardcoded responses, etc.), a project name, a project description, one or more project dates (e.g., a start date, a due date, a completion date, and/or other project dates), one or more project members (e.g., an owner, one or more other project members, member access information, and/or other project members and/or member information), a status and/or progress (e.g., an update, a hardcoded status update, a measured status, quantity of units of work remaining in a given project, completed units of work in a given project, and/or other status parameter), one or more attachments, notification settings, privacy, an associated URL, one or more interaction parameters (e.g., sources of the interactions, context of the interactions, content of the interactions, time for the interactions, and/or other interaction parameters), updates, ordering of units of work within the given project, state of a workspace for a given task within the given project, and/or other information.

Objective records may store objective information and/or other information. The objective information may include values of one or more objective parameters. The values of the objective parameters may be organized in objective records corresponding to business objectives managed, created, and/or owned within the collaboration environment. The business objectives may be associated with a set of units of work that may indirectly facilitate progress toward fulfillment of the business objectives. The set of units of work may not directly contribute to the progress. By way of non-limiting illustration, a connection between the set of units of work and a corresponding business objective may be indirect in that completion of at least one of the units of work may have no direct impact on progress toward fulfillment of the business objective. The concept of “no direct impact” may mean that completion of the at least one unit of work may not cause progress toward fulfillment of the business objective without independent action outside of the at least one unit of work. Instead, the fulfillment of the at least one business objective may make such independent action more likely (e.g., through coercion, assistance, education, incentivization, reminder, etc.). However, in some implementations, business objectives may be associated with a set of units of work that may directly facilitate progress toward fulfillment of the business objectives. Accordingly, completion of the set of units of work may directly contribute to the progress toward fulfillment.

Individual objective records may describe individual business objectives and identify sets of individual ones of the work unit records that specify the units of work associated with the individual business objectives. A given business objective may have one or more collaborators, and/or team members working on the given business objective. Business objectives may be created by a given user for the given user and/or created by the given user and assigned to be owned to one or more other users. Individual business objectives may include one or more of an individual goal, an individual sub-goal, and/or other business objectives assigned to be owned by a user and/or associated with one or more users.

In some implementations, business objectives may be derived from, and/or associated with, events and/or other information. The events may be external and/or integral to the collaboration environment. Events may include occurrences within an external resource (e.g., one or more external resources 122) and/or occurrences in the real world. External resources may include application programs accessible to the collaboration environment. An application program may be external to the collaboration environment and/or integrated into the collaboration environment. By way of non-limiting illustration, application programs may include social media applications, E-mail applications, messaging applications, presentation applications, file storage application, communication applications, news applications, and/or other application programs.

By way of non-limiting illustration, a business objective may be to reach a given quantity of subscribers on a social media page. The business objective may be derived from an event including a social media application showing subscribership to the social media page is reaching and/or exceeding the given quantity of subscribers. By way of non-limiting illustration, a business objective may be to increase the click-through-rate (CTR) on an ad on a webpage by a given percentage. The business objective may be derived from an event including an analytics program showing the CTR for the ad.

An occurrence within the real world may be determined through human observation with and/or without the assistance of a computer. By way of non-limiting illustration, a business objective may be to become more prominent in a given field of industry. The business objective may be derived from an event including the business being mentioned in an article written about the given field of industry. By way of non-limiting illustration, a business objective may be to onboard five new clients in a given month. The business objective may be derived from an event including observing the number of new clients being onboarded that given month. By way of non-limiting illustration, a business objective may be to increase the flow of foot traffic into a shop. The business objective may be derived from an event including observing the number of customers walking into the shop.

Individual sets of objective records may be defined by an objective record hierarchy. An objective record hierarchy may convey individual positions of objective records (and their corresponding business objectives) in the objective record hierarchy. Individual objective records may include hierarchical information defining an objective record hierarchy of the individual objective records. The hierarchical information of an objective record may include one or more of information identifying other objective records associated in an objective record hierarchy, a specification of the position of the objective record in the hierarchy, other relationships placed on the objective record by virtue of its position, and/or other information. In some implementations, as a consequence of the objective record hierarchies, the individual business objectives described in the individual objective records that are subordinate to the other individual objective records may be subordinate to the individual business objectives in the other individual objective records.

In some implementations, the one or more objective parameters may include one or more of an objective definition parameter, an objective progress parameter, and/or other parameters. The value of the objective definition parameter may describe a particular business objective. The values of an objective progress parameter may specify progress information for a particular business objective, and/or other information.

In some implementations, the business objectives may be described based on one or more of a business objective specification, one or more business objective dates (e.g., a start date, a due date, and/or dates), one or more members associated with a business objective (e.g., an owner, one or more other project/task members, member access information, and/or other business objective members and/or member information), one or more interaction parameters (e.g., indicating a given business objective was viewed, a given business objective was selected, how long the given business objective has been idle, a last interaction parameter indicating when and what user last interacted with the given business objective, users that interacted with the given business objective, and/or other interaction parameters indicating sources of the interactions, context of the interactions, content of the interactions and/or time for the interactions), notification settings, privacy, one or more custom fields (e.g., priority, cost, stage, and/or other custom fields), identification of units of work associated with a business objective, and/or other information.

A business objective specification may include one or more of what the business objective is (e.g., what is the desired outcome), an event associated with the business objective, an external resource associated with the business objective, and/or other information.

Progress information for the individual business objectives may convey progress toward fulfillment of the individual business objectives. The progress information for the individual business objectives may convey progress toward fulfillment of the individual business objectives. In some implementations, the progress toward fulfillment of the business objectives may be specified as one or more of a quantitative value, a qualitative value, and/or other information. In some implementations, the quantitative value may be a percentage of completion, an integer value, a dollar amount, and/or other values. In some implementations, progress toward fulfillment of the individual business objectives may be determined independently from incremental completion of the units of work in the individual sets of units of work associated with the individual business objectives. Meaning, the completion of the units of work associated with a given business objective may not directly progress the given business objective toward fulfillment, but completing the units of work may make accomplishing the business objective more likely (e.g., through coercion, assistance, education, incentivization, reminder, etc.). However, in some implementations, progress toward fulfillment of the individual business objectives may be directly determined based on incremental completion of the units of work in the individual sets of units of work associated with the individual business objectives.

It is noted that any metadata and/or values of parameters related to any users, projects, business objectives, and/or units of work may be considered values of user parameters, project parameters, objective parameters, and/or work unit parameters.

The client computing platform(s) 124 may monitor, and/or collect information for transmission to the one or more server(s) 102 to be stored as the environment state information. The client computing platform(s) 124 may obtain and/or collect the environment state information from the one or more server(s) 102.

The environment state component 108 may be configured to manage the environment state information and/or other information used in maintaining a collaboration environment. The environment state information may include one or more of work unit records describing units of work assigned to, created by, and/or managed by individual users within the collaboration environment, the user information, the work information, and/or other information used to define, support, and/or otherwise maintain the collaboration environment.

In some implementations, the environment state component 108 of machine-readable instructions 106 may be configured to effectuate transmission of the environment state information to client computing platform(s) 124, and/or vice versa. In some implementations, environment state component 108 may be configured to receive information over network 133 from client computing platforms(s) 124. Environment state component 108 may be configured to effectuate storage of the received information as environment state information to one or more user records 128, project records 130, work unit records 132, and/or other records.

In some implementations, collaboration environment component 110 of machine-readable instructions 107 of client computing platform(s) 124 may be configured to effectuate presentation of the collaboration environment. Presentation of the collaboration environment may be based on the environment state information and/or other information. The collaboration environment may include an environment in which users interact with and/or view the one or more units of work, projects, business objects, and/or other content managed via the collaboration work management platform. The collaboration environment may exist whether or not a given user is viewing and/or interacting with the collaboration environment. In some implementations, projects managed via the collaboration environment may include one or more units of work. The one or more units of work may be assigned to one or more users such that the one or more units of work assigned to a given user may appear on a given user's unit of work list within the collaboration environment.

In some implementations, user chat component 112 and/or chat application component 148 may be configured to implement instances of chat sessions to facilitate communication between the users within the collaboration environment. The communication may be synchronous, semi-synchronous, and/or asynchronous. User chat component 112 and/or chat application component 148 may receive an/or transmit the communications (e.g., textual communications, voice communications, video communications, etc.) that make up the chat sessions to the client computing platforms for presentation through graphical chat interfaces. The graphical chat interface may be presented on the client computing platforms 124 via display(s) 119 within and/or outside to the collaboration environment. The chat sessions may be hosted by the collaboration platform and/or one or more third party chat applications integrated with the collaboration platform via an application program interface (API). The chat-sessions may be provided by one or more third-party chat applications via one or more APIs. In some implementations the collaboration platform may host and/or provide one or more of the chat sessions. The graphical chat interface may include its own interface and/or a portion of one or more collaboration environment interfaces for displaying one or more units of work, business objectives, and/or projects for a given user.

In synchronous communication, individual users may receive communication inputs from other users in real-time or near real-time, i.e., without significant delay. In asynchronous communication, time delays may occur between sending communications inputs and receiving the sent communication inputs. In some implementations, the user chat component 112 and/or chat application component 148 may be configured to mediate asynchronous communication to ensure correct receiving orders.

The textual communications may be received and entered by the users via their respective client computing platforms and may be routed to and from the appropriate users through chat server(s) 140 via a chat session implemented by the chat application component 148. A chat session may include complete textual communication inputs from users who have participated in the chat session. The textual communication inputs in a chat session may be stored on and accessed from the electronic storage 142. In some examples, a chat session may be open ended such that it does not finish until a provider, administrator, moderator, and/or any other entities related to the collaboration environment decide not to provide the chat session. In some other examples, a chat session may be initiated and stopped by users at any time as desired.

By way of non-limiting illustration, a first chat session may be presented to the first user via a first chat interface. The first chat interface may be presented on a first client computing platform (i.e., via a first display) associated with the first user, and the first chat session may be presented to the second user via a second chat interface presented on a second client computing platform (i.e., via a second display) associated with the second user.

The content component 114 may be configured to obtain content information and/or other information. The content information may characterize content of the chat sessions between the users of the collaboration environment. The content of the chat sessions between the users of the collaboration environment may be characterized based on the content sent from one user to another. The content information for the chat sessions may be obtained at the conclusion of a chat session, and/or in real-time and/or near real-time during the chat session. Chat sessions may include a series of communications between two or more users of the collaboration environment. The chat sessions may facilitate communication between the two or more users. The chat sessions may include one or more of a messenger chat session, a video chat session, a phone chat session, and/or other chat sessions.

By way of non-limiting illustration, the chat sessions may include the first chat session between the first user and the second user and/or other chat sessions between other users. As such, first content information may characterize first content communicated from the first user to the second user of the first chat session may be obtained.

In some implementations, the chat sessions may be related to and/or specific to a given project, a user, a business objective, and/or unit of work within the collaboration environment, an E-mail, a particular textual message, audio recording, video, and/or other information. As such, the users participating in the given chat session may be working on and/or discussing the related and/or specific project, user, business objective, unit of work, E-mail, textual message, audio recording, video, and/or other information.

For example, the first chat session may be a unit of work-specific chat session. The first chat session may relate to Unit of work A. In some implementations, the chat sessions may be between two users and/or more than two users. Content component 114 may be configured to transcribe one or more spoken communications. In some implementations, content component 114 may be configured to determine a source and/or intended recipient of individual chat items within the chat session.

The content information obtained by content component 114 may describe the content included in a given chat session. By way of non-limiting example, content information may include one or more communication inputs by the users within the chat sessions, one or more spoken and/or transcribed communications spoken by the users within the chat sessions, one or more words and/or phrases included in the chat sessions, the source of the spoken and/or textual communications, the intended recipient of the spoken and/or textual communications, and/or other content information. The communication inputs in the chat session may be presented through a graphical chat interface on display(s) 119 of the client computing platform(s) 124.

In some implementations, the content information may include context information. Context information may include setting information, content information for communications immediately preceding and/or following a trigger word and/or phrase, information describing the one or more units of work, business objectives, E-mails, audio recordings, videos, and/or projects the chat session relates to, user information for one or more of the users participating in the chat session (e.g., one or more projects and/or units of work associated with the user, the user's role/department/qualifications, historical user information, and/or other user information), and/or other context information.

In some implementations, the chat sessions may facilitate synchronous and/or semi-synchronous communication between the users of the collaboration environment. By way of non-limiting example, the synchronous and/or semi-synchronous communication may include phone communications, video communications, messenger communications, and/or other communication. In some implementations, the chat sessions may be text chat sessions. In some implementations, the chat sessions may be voice and/or video chat sessions.

The content component 114 may be configured to identify one or more content items and/or other information. The one or more content items may be identified from the content of the chat sessions communicated from individual users. The one or more content items may be identified prior to sending the content of the communication to other ones of the individual users in the chat sessions.

The individual content items may include one or more of system records, external resource records, and/or other records. The system records may include one or more of the user records 128, the project records 130, the work unit records 132, the objective records (not shown), records locally stored to electronic storage 126, and/or other records. The records locally stored to electronic storage 126 may include one or more of an image, an audio file, a video file, a multimedia presentation file, and/or other records.

External resource records may include one or more of an E-mail, an image file, an image post, a video file, a video post, an audio recording, an audio post, a multimedia presentation file, and/or other external resource records that may be associated with external resource(s) 122. Individual external resource records may be defined by one or more media attributes. By way of non-limiting illustration, media attributes associated with external resource records may include a subject to an E-mail, a body to an E-mail, recipient of an E-mail, application for a post (e.g., image and/or video), caption of a post, title of a post, name of a file (e.g., audio file, image file, video file, multimedia presentation file), and/or other media attributes. The external resource records may be obtained from sources outside system 100 (e.g., external resource(s) 122). It is noted that while one or more implementations described herein may be directed to identifying content items, this is for illustrative purposes only. Instead, it is to be understood that the features and/or functions described herein may be extended to other content items and/or other content.

In some implementations, individual content items may be identified in real-time and/or near real-time during the chat session. By way of non-limiting example, as the user starts typing within the chat interface, content component 114 may identify a first content item from the first content communicated from the first user and prior to sending the first content to the second user of the first chat session. The content items, in some implementations, may be identified at or near the conclusion of the chat sessions or subsequent to entrance of the first content.

In some implementations, one or more content items identified based on the content from the chat sessions may be presented to one or more of the users as one or more potential content items. The potential content items may be presented to the one or more users for confirmation and/or acceptance. One or more of the users may accept and/or confirm one or more of the potential content items at the conclusion of the given chat session to identify the content items as content items of interest. A chat session may conclude when: a threshold amount of time passes without any communication from one or more users, a user exits or closes the chat interface, the user minimizes the chat interface, the user responds to a request with acceptance language (e.g., “sure”, “okay”, “will do”, “I'll take care of it.”, etc.) and/or the user otherwise concludes the chat session.

In some implementations, the one or more content items may be identified based on information from multiple users within a chat session being pieced together to identify the one or more content items.

In some implementations, the content items may be automatically identified and/or identified by the users based on the content information. By way of non-limiting example, the content component 114 may be configured to identify identification language based on the content information for the chat sessions. Responsive to the content component 114 identifying identification language in response to communications triggering identification of a content item, content component 114 may automatically identify the content item on behalf of the user.

In some implementations, the content component 114 may be configured to identify potential content in the content of the chat sessions that leads to the identification of the one or more content items. The potential content from the chat sessions that leads to the identification of the one or more of the content items may include one or more trigger phrases and/or words. The potential content may include content that is likely to trigger identification of the one or more content items. The trigger phrases and/or words may include one or more of a name of a user linked to a unit of work, a title of a unit or work, a description of a unit of work, a date associated with a unit of work, a name of a user linked to a project, a title of a project, a description of a project, a date associated with a project, a name of a user linked to a business objective, a title of a business objective, a description of a business objective, a date associated with a business objective, a name of a user linked to an E-mail, a subject of an E-mail, a body of an E-mail, a date associated with an E-mail, a name of media (e.g., audio recording, video, photo), a caption of media, a name of a user linked to media, a title of media, a description of media, a date (e.g., postdate, release date), and/or other trigger words and/or phrases. Thus, the one or more of the content items may be identified responsive to identifying one or more of the trigger phrases and/or words. By way of non-limiting illustration, the first content item may be identified responsive to identifying a first trigger phrase and/or word in the first chat session based on the first content communicated from the first user and prior to sending the first content to the second user.

In some implementations, content component 114 may be configured to identify potential trigger phrases and/or words based on the potential content identified. In some implementations, content component 114 may be configured to determine and/or identify one or more words and/or phrases as trigger phrases and/or words. Content component 114 may be configured to identify potential content in the content of the chat sessions that leads to search and retrieval of one or more of the content items by the users. The potential content that leads to search and retrieval of one or more of the records in the collaboration environment by the users may be identified based on the environment state information.

The trigger phrases and/or words may indicate an identification and/or one user's request, desire, inquiry, and/or need to another user. By way of non-limiting example, content component 114 may monitor chat sessions between users in the collaboration environment and/or identify that whenever a user states “Will you complete X . . . ” they typically search a unit of work for X shortly thereafter. As such, content component 114 may identify “will you” as a trigger phrase. By way of non-limiting example, the trigger phrases and/or words may include one or more of will you, can you, could you, please, by a given date, before the given date, we need, I need, I want, would be grateful if, and/or you could.

In some implementations, the content items may be further identified based on context of the chat sessions. As such, for example, the first unit of work may be identified based on first context information related to the first chat session, the first user and/or the second user, a first project and/or unit of work, and/or other context information. The records may define a unit of work within an overarching project, a subunit of work (e.g., to-do items, action items, business objectives, an E-mail, a project, media, and/or other units of work.

In some implementations, automated assistance component 116 may be configured to identify a requested action related to the one or more content items identified. The actions requested may include modifying, changing, adjusting, adding, and/or removing one or more characteristics associated with individual content items. As used herein, one or more characteristics of individual ones of the content items may refer to one or more of a work unit parameter, user parameter, and/or objective parameter associated with work unit records, user records, and objective records, respectively, and/or media attributes associated with external resource records that may be modified by the users based on the content information. By way of non-limiting example, as the user starts typing within the graphical chat interface, automated assistance component 116 may identify one or more characteristics associated with individual identified content items that should be modified, changed, adjusted, added, and/or removed. In some implementations, based on the one or more characteristics identified, automated assistance component 116 may be configured to verify values defining the individual characteristics. The requested actions, in some implementations, may be fulfilled at or near the conclusion of the chat sessions or immediately subsequent to the verification of the values based on the verification of the values.

By way of non-limiting illustration, the first user may type “Did you reassign Task A to Tom?” and automated assistance component 116 may identify the content item, Task A, and verify whether the assignee value is Tom. Upon verifying that the assignee value is not assigned to Tom, automated assistance component 116 may assign Task A to Tom.

In some implementations, the requested actions identified related to the one or more content items based on the content from the chat sessions may be presented to one or more of the users as one or more potential actions. The potential actions may be presented to the one or more users for confirmation and/or acceptance. The potential actions presented may specify determined and/or recommended values to individual characteristics for a given content item. One or more of the users may accept and/or confirm one or more of the potential actions at the conclusion of the given chat session or during the given chat session to fulfill the requested actions. Conversely, the one or more users may deny and/or decline the potential actions. By way of non-limiting illustration, a first potential action specifying assign Task A to Tom may be presented to the first user. The first user may accept and/or confirm to assign Task A to Tom, or conversely, deny the potential action and not assign Task A to Tom.

In some implementations, automated assistance component 116 may be configured to identify one or more content items that should be generated. The one or more content items, in some implementations, may be generated at or near the conclusion of the chat sessions or during the chat sessions. In some implementations, the one or more content items may be generated based on information from multiple users within a chat session being pieced together to generate the one or more content items. Generating the one or more content items may include determining and/or recommending which values of characteristics of the content items based on the content from the chat session.

By way of non-limiting illustration, automated assistance component 116 may generate a unit of work and determine that the unit of work should be assigned to a User A and due on Date B. By way of another non-limiting illustration, automated assistance component 116 may generate an E-mail (e.g., via an application integrated with the collaboration platform) and define the recipient, define a portion of a body of the E-mail, and define a subject of the E-mail.

In some implementations, the content items may be automatically generated and/or accepted by the individual users based on the content information. By way of non-limiting example, the automated assistance component 116 may be configured to identify acceptance language based on the content information for the chat sessions communicated by the first user. Responsive to automated assistance component 116 identifying acceptance language communicated by the first user in response to communications triggering generation of a content item, automated assistance component 116 may automatically accept the generated content item on behalf of the first user.

In some implementations, automated assistance component 116 may identify one or more content items that should and/or could be generated and/or provided the user with one or more prompting questions for generating the one or more content items. By way of non-limiting example, if user A starts typing to users B, C, and D “We need to follow-up with X supplier . . . ”, automated assistance component 116 may prompt user A with one or more questions for generating the unit of work (e.g., “Who should follow up with X supplier?”, “When do you want this user to follow up with X supplier by?”, etc.). Automated assistance component 116 may generate the unit of work for following-up with X supplier based on the responses to these questions.

Generating the content items for the users based on the content from the chat sessions may include automatically generating one or more values of one or more characteristics describing the content items. Generating the content items based on the content information may include automatically initiating the one or more content items, and/or automatically generating one or more values of one or more characteristics describing the content items. As such, by way of non-limiting example, generating a first task may include generating one or more values of one or more work unit parameters describing the first task. In some implementations, by way of non-limiting example, the one or more values of the one or more work unit parameters may include one or more of a title, a description, a due-date, an assignee, a start date, a project and/or unit of work associated with the generated unit of work, a dependency within a hierarchy, and/or other values.

The one or more content items may be further generated based on the context of the chat sessions. As such, the first content item may be generated based on first context information related to the first chat session, the first user and/or the second user, a first project and/or unit of work, and/or other context information. The content items may include a unit of work within an overarching project, a subunit of work (e.g., to-do items, action items, objectives, and/or other units of work one or more users should and/or plan on accomplishing) under an overarching unit of work, a social media post, an E-mail, and/or other content items.

The automated assistance component 116 may be configured to effectuate presentation of one or more automated communications within the chat sessions. The one or more automated communications may correspond to the one or more content items identified from the content of the chat sessions. The one or more automated communications may include one or more of textual communications, an instance of a content item, a copy of a content item, a link to a content item, potential actions, and/or other content. In some implementations, the automated communications may include an informative textual message of requested actions that have been or will be fulfilled. By way of non-limiting illustration, a first automated communication may be presented in the first chat session for the first user. The first automated communication may correspond to the first content item. The first automated communication may include the first content item, a link to the first content item, an instance of the first content item, and/or other content.

The presentation of individual automated communications in the chat sessions may suspend the sending of the content of the communication to the other ones of the individual users in the chat sessions. Presenting the first automated communication may suspend the sending of the first content to the second user of the first chat session. The first content and the first automated communication may be presented in the first chat interface without presenting the first content and the first automated communication in the second chat interface while the sending of the first content to the second user device is suspended.

In some implementations, automated assistance component 116 may be configured to effectuate one or more automation restrictions so that the automated assistance component 116 performs its functionality in a specialized manner. By way of non-limiting illustration, one or more automation restrictions may act as a filter to limit functionally of automated assistance component 116 based on one or more of particular times of day, particular days, for particular content items, and/or other specified manners.

The one or more automation restrictions may be associated with the users by storing information defining the one or more automation restrictions in user records of the users. The one or more automation restrictions may be initiated and/or defined with user input from individual users of the chat sessions via one or more user interface elements. The user interface elements may include one or more of text input fields, drop down menus, check boxes, display windows, virtual buttons, virtual calendars, and/or other filter user interface elements that facilitate specifying components of the filter. In some implementations, the one or more automation restrictions may be initiated for particular chat sessions with specific users, in connection with particular work units, in connection with particular projects, in connection with particular objectives, and/or other considerations. In some implementations, a user interface element may be selected to facilitate reoccurrence of the one or more automation restrictions. By way of non-limiting illustration, the second user may initiate a first automation restriction on the first chat session with the first user so that the automated assistance component 116 identifies content items and presents automated communications corresponding to the content items between 12:00 PM to 2:00 PM on Monday. By way of another non-limiting illustration, the second user may initiate a second automation restriction, different from the first automation restriction, for all communications via the chat sessions every 12:00 AM Saturday to 11:59 PM Sunday.

In some implementations, the automated assistance component 116 may effectuate presentation of an automation override user interface element in the graphical chat interfaces. The automation override user interface element may include a virtual button, a link, and/or other user interface elements which may be selected by a user. The selection of the automation override user interface element may cause the sending of the content that has otherwise been suspended. By way of non-limiting illustration, the first chat interface may present the automation override user interface element. Selection of the automation override user interface element may cause the first content to be sent to the second user via the second chat interface presented on the second computing platform of the second user.

In some implementations, automated assistance component 116 may be configured to effectuate presentation of viewing panes within the graphical chat interfaces. The individual viewing panes may comprise portions of the graphical chat interfaces that may display one or more automated communications. In some implementations, the user may select a full and/or partial viewing pane of the graphical chat interface within the graphical user interfaces associated with the collaboration environment presented on displays of the client computing platform(s) 124. In some implementations, the portions of the graphical chat interfaces that may display the one or more automated communications may be presented on a left side portion of a given graphical chat interface, a right side portion of the given graphical chat interface, a top portion of the given graphical chat interface, a bottom portion of the given graphical chat interface, a window pop-up of the given graphical chat interface, in-line with the content communicated by the users, and/or other portions. The portion and/or size thereof which may display the one or more automated communications may be pre-set by the collaboration environment and modifiable by the users, or may be fixed and unmodifiable by the users. For example, the viewing pane may comprise the right-side portion of the given graphical chat interface that comprises half of the given graphical chat interface.

In some implementations, an individual automated communication may correspond to an individual content item by virtue of the individual content item being accessible via the individual automated communication. In some implementations, the accessibility of the individual content item from the individual automated communication may be provided through a link included in the individual automated communication. In some implementations, the individual content item may be accessible via the link by way of the viewing pane. That is, upon a user selecting the link to access the individual content item, the content items may be accessible through the viewing pane.

In some implementations, an individual automated communication corresponds to an individual content item by virtue of the individual automated communication including an instance of the individual content item. In some implementations, the instance of the individual content item may be presented via the viewing pane. In some implementations, the instance of the individual content may be a read-only version of the individual content item. The read-only version of the individual content item in the instance of the individual content may be uneditable via the individual automated communication or viewing pane. For example, the automated communications may include read-only automated communications of work unit records and thus, the work unit records are uneditable via the automated communications.

In some implementations, the instance of the individual content item may be editable via the automated communication. For example, the automated communication may include an instance of objective record where the objective record may be editable via the automated communication of the objective record. Some or all of the users participating in the chat sessions may be permitted to edit the content item (e.g., the objective record) via the automated communications. Editing the content items may include modifying, changing, adjusting, adding, and/or removing the one or more characteristics associated with individual ones of the content items.

Content component 114 may be configured to store information defining the records identified and subsequently edited as part of the environment state information. Content component 114 may be configured to communicate with collaboration environment component 110 and/or environment state component 108 to effectuate storage of the information defining the records identified and edited as part of the environment state information.

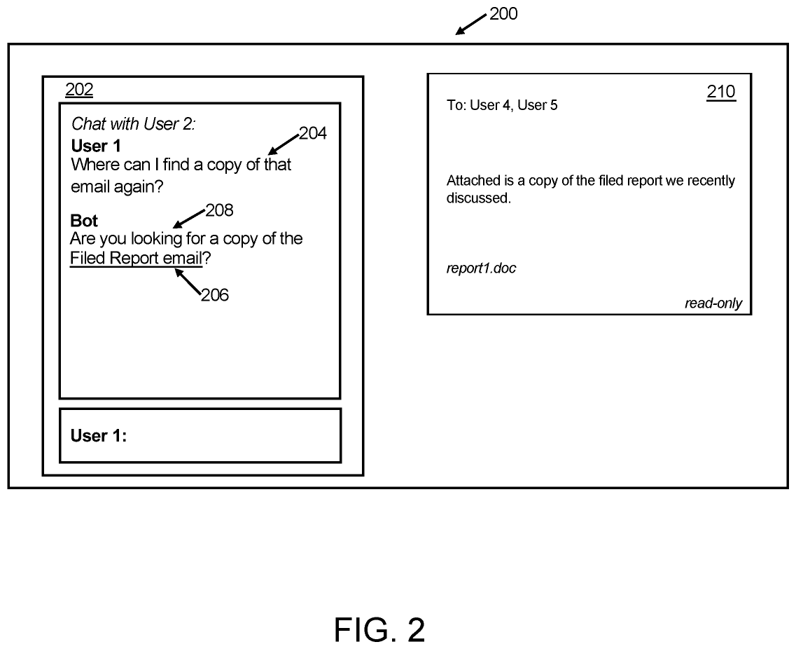

FIG. 2 illustrates an exemplary chat interface 200, in accordance with one or more implementations. In some implementations, graphical chat interface 200 may be presented within a view of a collaboration environment and/or outside of the collaboration environment. Chat interface 200 may include one or more of a communications portion 202 and/or other portions. Communications portions 202 may facilitate an exchange of textual communication between users, for example, User 1 and User 2. The textual communication may include a textual communication 204 sent from User 1 to User 2 via graphical chat interface 200. Content from the textual communications 204 may be used to identify a content item 206 (e.g., an E-mail mentioned in the text). An automated communication 208 may be presented to User 1 corresponding to content item 206 by which User 1 may access content item 206 via a link included in the automated communication 208. Upon selection of the link, User 1 may access a read-only version 210 of content item 206 in a viewing pane. Presentation of automated communication 208 may suspend sending textual communication 204 to User 2 due to an automated response.

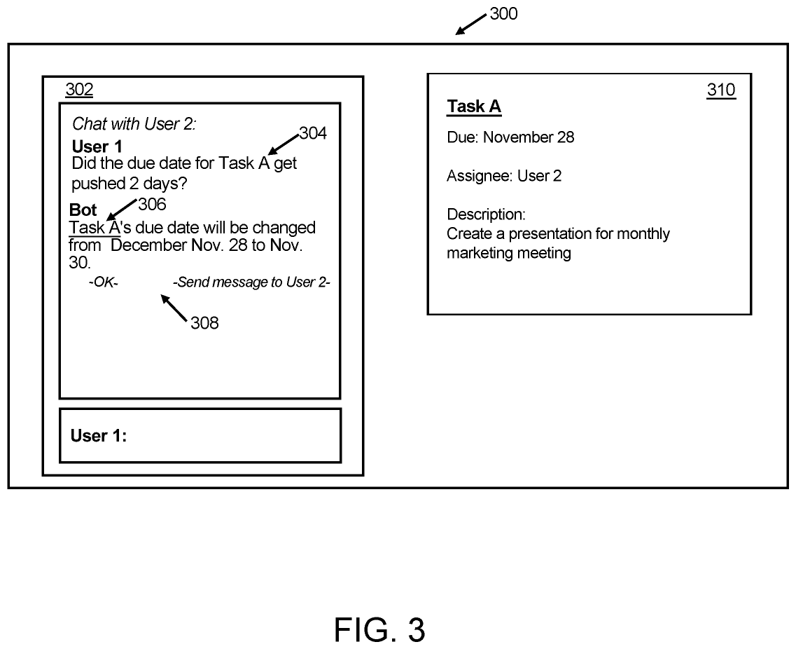

FIG. 3 illustrates an exemplary chat interface 300, in accordance with one or more implementations. In some implementations, graphical chat interface 300 may be presented within a view of a collaboration environment and/or outside of the collaboration environment. Chat interface 300 may include a communications portion 302 and/or other portions. Communications portions 302 may facilitate an exchange of textual communication between users, for example, User 1 and User 2. The textual communication may include a textual communication 304 sent from User 1 to User 2 via graphical chat interface 300. Content from the textual communications 304 may be used to identify a content item 306 (e.g., Task A) and a requested action (e.g., pushing due date 2 days) related to content item 306. An automated communication 308 may be presented to User 1 corresponding to content item 306 by which User 1 may access an instance 310 of content item 306 via a link included in the automated communication 308. Automated communication 308 may include an informative message addressing the requested action (e.g., due date will be changed from Nov. 28 to Nov. 30). Automated communication 308 may further include an automation override user interface element (e.g., “Send message to User 2”) that User 1 may select to cause the sending of textual communication 304 to User 2 instead of accepting automated communication 308 and its informative message (e.g., “OK”).

Returning to FIG. 1, in some implementations, server(s) 102, client computing platform(s) 124, chat servers(s) 140, and/or external resource(s) 122 may be operatively linked via one or more electronic communication links. For example, such electronic communication links may be established, at least in part, via a network 133 such as the Internet and/or other networks. It will be appreciated that this is not intended to be limiting, and that the scope of this disclosure includes implementations in which server(s) 102, chat server(s) 124, client computing platform(s) 124, and/or external resource(s) 122 may be operatively linked via some other communication media.

External resource(s) 122 may include one or more sources of information outside of system 100, external entities participating with system 100, source of content (including one or more of E-mails, videos, video posts, audio recordings, audio posts, and/or other content), and/or other resources. In some implementations, some or all of the functionality attributed herein to external resource(s) 122 may be provided by resources included in system 100.

Server(s) 102 may include electronic storage 126, one or more processors 104, and/or other components. Chat server(s) 140 may include electronic storage 142, one or more processors 144, and/or other components. Client computing platform(s) 124 may include electronic storage 120, one or more processors 105, and/or other components. Server(s) 102, chat server(s) 140, and client computing platform(s) 124 may include communication lines, or ports to enable the exchange of information with a network and/or other computing platforms. Illustration of server(s) 102, chat server(s) 140, and client computing platform(s) 124 in FIG. 1 are not intended to be limiting. Server(s) 102, chat server(s) 140, and client computing platform(s) 124 may include a plurality of hardware, software, and/or firmware components operating together to provide the functionality attributed herein to server(s) 102, chat server(s) 140, and client computing platform(s) 124. For example, server(s) 102, chat server(s) 140, and client computing platform(s) 124 may be implemented by a cloud of computing platforms operating together.

Processor(s) 104 may be configured to provide information processing capabilities in server(s) 102. Processor(s) 144 may be configured to provide information processing capabilities in chat server(s) 140. Processor(s) 105 may be configured to provide information processing capabilities in client computing platform(s) 124. As such, processor(s) 104, 144, and 105 may individually include one or more of a digital processor, an analog processor, a digital circuit designed to process information, an analog circuit designed to process information, a state machine, and/or other mechanisms for electronically processing information. Although processor(s) 104, 144, and 105 are shown in FIG. 1 as single entities, this is for illustrative purposes only. In some implementations, processor(s) 104, 144, and 105 may individually include a plurality of processing units. These processing units may be physically located within the same device, or processor(s) 104, 144, and 105 may represent processing functionality of a plurality of devices operating in coordination. Processor(s) 104, 144, and 105 may be configured to execute components 108, 110, 112, 114, 116, 148, and/or other components individually or in coordination. Processor(s) may be configured to execute components 108, 110, 112, 114, 116, 148, and/or other components by software; hardware; firmware; some combination of software, hardware, and/or firmware; and/or other mechanisms for configuring processing capabilities on processor(s). As used herein, the term “component” may refer to any component or set of components that perform the functionality attributed to the component. This may include one or more physical processors during execution of processor readable instructions, the processor readable instructions, circuitry, hardware, storage media, or any other components.

It should be appreciated that although components 108, 110, 112, 114, 116, and 148 are illustrated in FIG. 1 as being implemented within single respective processing units, in implementations in which each processor(s) 104, 144, and 105 includes multiple processing units, one or more of components 108, 110, 112, 114, 116, and/or 148 may be implemented remotely from the other components. The description of the functionality provided by the different components 108, 110, 112, 114, 116, and/or 148 described below is for illustrative purposes, and is not intended to be limiting, as any of components 108, 110, 112, 114, 116, and/or 148 may provide more or less functionality than is described. For example, one or more of components 108, 110, 112, 114, 116, and/or 148 may be eliminated, and some or all of its functionality may be provided by other ones of components 108, 110, 112, 114, 116, and/or 148. As another example, processor(s) 104, 144, and 105 may be configured to execute one or more additional components that may perform some or all of the functionality attributed below to one of components 108, 110, 112, 114, 116, and/or 148.

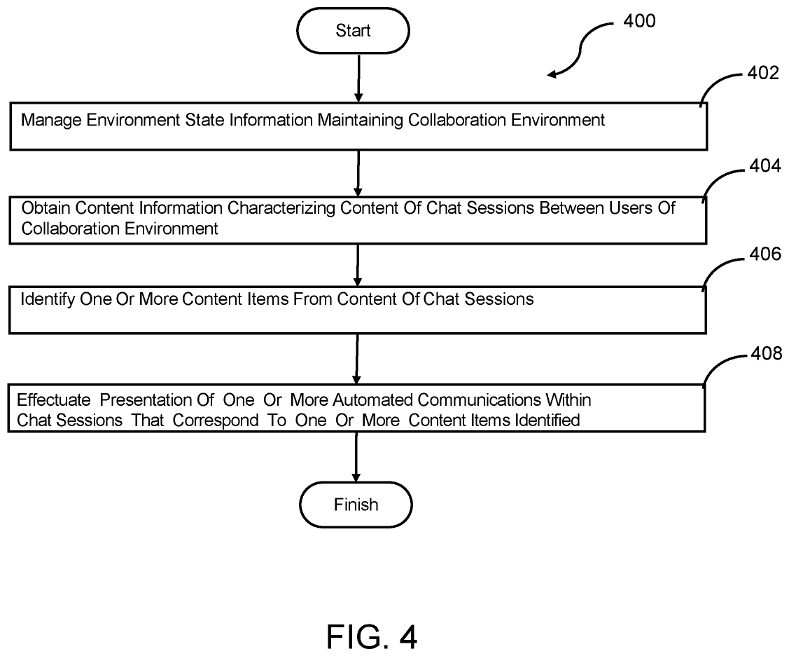

FIG. 4 illustrates a method 400 for providing automated assistance in chat sessions between users of a collaboration environment, in accordance with one or more implementations. The operations of method 400 presented below are intended to be illustrative. In some implementations, method 400 may be accomplished with one or more additional operations not described, and/or without one or more of the operations discussed. Additionally, the order in which the operations of method 400 are illustrated in FIG. 4 and described below is not intended to be limiting.

In some implementations, method 400 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 400 in response to instructions stored electronically on an electronic storage medium. The one or more processing devices may include one or more devices configured through hardware, firmware, and/or software to be specifically designed for execution of one or more of the operations of method 400.

An operation 402 may manage environment state information maintaining a collaboration environment and/or other information. The collaboration environment may be configured to facilitate interaction by users with the collaboration environment. The environment state information may include work unit records describing units of work assigned to, created by, and/or managed by individual users within the collaboration environment and/or other records. Operation 402 may be performed by one or more hardware processors configured by machine-readable instructions including a component that is the same as or similar to environment state component 108, in accordance with one or more implementations.

An operation 404 may include obtaining content information characterizing content of the chat sessions between the users of the collaboration environment. The chat sessions may facilitate synchronous communication between the users. Operation 404 may be performed by one or more hardware processors configured by machine-readable instructions including a component that is the same as or similar to content component 114, in accordance with one or more implementations.

An operation 406 may include identifying one or more content items. The one or more content items may be identified from the content of the chat sessions communicated from individual users and prior to sending the content to other ones of the individual users in the chat sessions. Operation 406 may be performed by one or more hardware processors configured by machine-readable instructions including a component that is the same as or similar to content component 114, in accordance with one or more implementations.

An operation 408 may include effectuating presentation of one or more automated communications within the chat sessions. The one or more automated communications may correspond to the one or more content items identified from the content from the chat sessions. The presentation of individual automated communications in the chat sessions may suspend the sending of the content to the other ones of the individual users in the chat sessions. Operation 408 may be performed by one or more hardware processors configured by machine-readable instructions including a component that is the same as or similar to automated assistance component 116, in accordance with one or more implementations.

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

1. A system configured to provide automated assistance in chat exchanges between users of a collaboration environment, the system comprising:
one or more physical processors configured by machine-readable instructions to:
manage environment state information maintaining a collaboration environment, the collaboration environment being configured to facilitate interaction by users with the collaboration environment, the environment state information including work unit records and user records, the user records describing the users of the collaboration environment, the work unit records describing units of work assigned to individual users within the collaboration environment who are expected to accomplish one or more actions to complete the units of work, the work unit records including a first work unit record describing a first unit of work previously assigned to an individual user within the collaboration environment who is expected to accomplish a set of one or more actions to complete the first unit of work, wherein the first work unit record is accessible to the users through a first dedicated view of the collaboration environment that displays information included in the first work unit record through which the users view and edit the information included in the first work unit record, and wherein the first work unit record includes one or more of a description of the first unit of work, an identification of the individual user assigned to the first unit of work, or a due date for completion of the first unit of work by the individual user;
implement instances of chat exchanges to facilitate synchronous communication between the users of the collaboration environment, and transmit textual communications that make up content of the chat exchanges to client computing platforms for presentation through graphical chat interfaces, the graphical chat interfaces being presented on the client computing platforms within and/or outside the collaboration environment, wherein the chat exchanges include a first chat exchange between a first user and a second user, and wherein the first chat exchange is presented to the first user via a first chat interface presented on a first client computing platform associated with the first user, and the first chat exchange is presented to the second user via a second chat interface presented on a second client computing platform associated with the second user;
obtain content information characterizing the content of the chat exchanges between the users of the collaboration environment, wherein first content information characterizes first content input by the first user to communicate to the second user of the first chat exchange;
identify the first work unit record based on the first content input by the first user and prior to sending the first content to the second user of the first chat exchange;
effectuate presentation of a first automated communication in the first chat exchange for the first user, wherein the first automated communication comprises a read-only version of the first dedicated view of the collaboration environment displaying the information included in the first work unit record such that the information included in the first work unit record is uneditable through the read-only version, and wherein presenting the first automated communication suspends the sending of the first content to the second user of the first chat exchange such that the first content and the first automated communication are presented in the first chat interface without presenting the first content in the second chat interface by virtue of suspension of the sending of the first content to the second user;
effectuate presentation of an automation override virtual button in the first chat interface, wherein selection of the automation override virtual button overrides the suspension of the sending of the first content to the second user;
obtain user input information conveying user input into the first chat interface, the user input including the selection of the automation override virtual button by the first user; and
responsive to the user input including the selection of the automation override virtual button by the first user, override the suspension of the sending of the first content to the second user by causing the first content input by the first user to be sent to the second user of the first chat exchange so that the first content is presented in the second chat interface.

2. (canceled)

3. (canceled)

4. The system of claim 1, wherein the one or more physical processors are further configured by the machine-readable instructions to:
identify potential content in the content of the chat exchanges that leads to the identification of one or more of the work unit records.

5. The system of claim 4, wherein the potential content from the chat exchanges that leads to the identification of the one or more of the work unit records includes one or more trigger phrases and/or words.

6. (canceled)

7. (canceled)

8. The system of claim 1, wherein the first automated communication further comprises a link to the first dedicated view of the collaboration environment displaying the information included in the first work unit record through which the users are able to view and edit the information included in the first work unit record, such that selection of the link from the first automated communication causes the first dedicated view to be presented.

9. (canceled)

10. (canceled)

11. A method to provide automated assistance in chat exchanges between users of a collaboration environment, the method comprising:
managing environment state information maintaining a collaboration environment, the collaboration environment being configured to facilitate interaction by users with the collaboration environment, the environment state information including work unit records and user records, the user records describing the users of the collaboration environment, the work unit records describing units of work assigned to individual users within the collaboration environment who are expected to accomplish one or more actions to complete the units of work, the work unit records including a first work unit record describing a first unit of work previously assigned to an individual user within the collaboration environment who is expected to accomplish a set of one or more actions to complete the first unit of work, wherein the first work unit record is accessible to the users through a first dedicated view of the collaboration environment that displays information included in the first work unit record through which the users view and edit the information included in the first work unit record, and wherein the first work unit record includes one or more a description of the first unit of work, an identification of the individual user assigned to the first unit of work, or a due date for completion of the first unit of work by the individual user;
implementing instances of chat exchanges to facilitate synchronous communication between the users of the collaboration environment, and transmitting textual communications that make up content of the chat exchanges to client computing platforms for presentation through graphical chat interfaces, the graphical chat interfaces being presented on the client computing platforms within and/or outside the collaboration environment, wherein the chat exchanges include a first chat exchange between a first user and a second user, and wherein the first chat exchange is presented to the first user via a first chat interface presented on a first client computing platform associated with the first user, and the first chat exchange is presented to the second user via a second chat interface presented on a second client computing platform associated with the second user;
obtaining content information characterizing the content of the chat exchanges between the users of the collaboration environment, wherein first content information characterizes first content input by the first user to the second user of the first chat exchange;
identifying the first work unit record based on the first content input by the first user and prior to sending the first content to the second user of the first chat exchange;
effectuating presentation of a first automated communication in the first chat exchange for the first user, wherein the first automated communication comprises a read-only version of the first dedicated view of the collaboration environment displaying the information included in the first work unit record such that the information included in the first work unit record is uneditable through the read-only version, and wherein presenting the first automated communication suspends the sending of the first content to the second user of the first chat exchange, including effectuating presentation of the first content and the first automated communication in the first chat interface without presenting the first content in the second chat interface by virtue of suspension of the sending of the first content to the second user;
effectuating presentation of an automation override virtual button in the first chat interface, wherein selection of the automation override virtual button overrides the suspension of the sending of the first content to the second user;
obtaining user input information conveying user input into the first chat interface, the user input including the selection of the automation override virtual button by the first user; and
responsive to the user input including the selection of the automation override virtual button by the first user, overriding the suspension of the sending of the first content to the second user by causing the first content input by the first user to be sent to the second user of the first chat exchange so that the first content is presented in the second chat interface.

12. (canceled)

13. (canceled)

14. The method of claim 11, further comprising:
identifying potential content in the content of the chat exchanges that leads to the identification of one or more of the work unit records.

15. The method of claim 14, wherein the potential content from the chat exchanges that leads to the identification of the one or more of the work unit records includes one or more trigger phrases and/or words.

16. (canceled)

17. (canceled)

18. The method of claim 11, wherein the first automated communication further comprises a link to the first dedicated view of the collaboration environment displaying the information included in the first work unit record through which the users are able to view and edit the information included in the first work unit record, such that selection of the link from the first automated communication causes the first dedicated view to be presented.

19. (canceled)

20. (canceled)
